(19) United States
(12) Patent Application Publication
(10) Pub. No.: US 2023/0368308 A1
(43) Pub. Date: Nov. 16, 2023

(54) REVENUE RECONCILIATION SERVICE IN HOSPITALITY BOOKING SYSTEM

(71) Applicant: Sonder Inc., San Francisco, CA (US)

(72) Inventors: Patrick Themessl-Huber, Kitchener (CA); Lauren Alexandra Campbell, Montreal (CA)

(21) Appl. No.: 17/663,166

(22) Filed: May 12, 2022

(51) Int. Cl. G06Q 40/00; G06Q 10/02

(52) U.S. Cl. CPC G06Q 40/123; G06Q 10/02

(57) ABSTRACT

A method comprises: receiving, by a revenue reconciliation service of a hospitality booking system, a first request from operational software of the hospitality booking system, the first request instructing the revenue reconciliation service to make a change regarding a booking, the change corresponding to a revenue change for the booking; providing, by the revenue reconciliation service and to the operational software in response to the first request, revenue state information for the booking, the revenue state information reflecting the change and including every active receivable invoice for the booking; receiving, by the revenue reconciliation service after providing the revenue state information, a confirmation from the operational software regarding the booking; and providing, by the revenue reconciliation service and in response to the confirmation, a sales order to an accounting system of the hospitality booking system.

### TECHNICAL FIELD

This document relates to a revenue reconciliation service in a hospitality booking system.

### BACKGROUND

In the hospitality industry, guest interactions are not limited to payments, check-in events, and check-out events. Rather, hospitality providers perform a range of types of actions regarding a stay. Many of these actions can impact the hospitality provider's revenue. Moreover, some of these actions can be difficult to reconcile within the booking system, often requiring human intervention by a specialist or expert. For example, accounting software can go out of synchronization with the software that is used for booking stays at hospitality units.

### SUMMARY

In a first aspect, a method comprises: receiving, by a revenue reconciliation service of a hospitality booking system, a first request from operational software of the hospitality booking system, the first request instructing the revenue reconciliation service to make a change regarding a booking, the change corresponding to a revenue change for the booking; providing, by the revenue reconciliation service and to the operational software in response to the first request, revenue state information for the booking, the revenue state information reflecting the change and including every active receivable invoice for the booking; receiving, by the revenue reconciliation service after providing the revenue state information, a confirmation from the operational software regarding the booking; and providing, by the revenue reconciliation service and in response to the confirmation, a sales order to an accounting system of the hospitality booking system.

Implementations can include any or all of the following features. The revenue reconciliation service provides the revenue state information in a preview mode. Providing the revenue state information in the preview mode involves a confirmation flag not being set on the revenue state information in a database of the revenue reconciliation service when the revenue state information is provided, the method further comprising setting, by the revenue reconciliation service and in response to the confirmation, the confirmation flag on the revenue state information in the database. The method further comprises checking, by the revenue reconciliation service and in response to the first request, whether the database includes an unconfirmed previous request regarding the booking. The database does include the unconfirmed previous request regarding the booking, the method further comprising disposing of the unconfirmed previous request before providing the revenue state information. The method further comprises determining the revenue state information by the revenue reconciliation service and in response to the first request. Determining the revenue state information comprises: crediting all receivable invoices of the booking; and creating a new receivable invoice for the booking, the new receivable invoice reflecting the change according to the first request. Creating the new receivable invoice comprises performing a new tax determination for the booking regarding the change. A previous receivable invoice of the booking included a first line item associated with a first tax line item, wherein creating the new receivable invoice comprises including a second line item associated with a second tax line item, and wherein the second line item and the second tax line item reflect the change. The operational software had notified the revenue reconciliation service, before the revenue reconciliation service provided the revenue state information, about a settlement that had been received regarding the booking, the method further comprising applying the settlement to the new receivable invoice for the booking. The change is at least partially specified by a line item included in the first request, the method further comprising determining, by the revenue reconciliation service, whether a daily rate is specified for the line item. In response to a determination that no daily rate is specified for the line item, the method further comprises computing the daily rate for the line item and including the daily rate in the revenue state information. The booking initially comprised a stay at a first unit for a time period, and wherein the change specified by the first request comprises a relocation of the stay from the first unit to a second unit for at least part of the time period. The booking is associated with a gross total amount for the stay at the first unit for the time period, wherein providing the revenue state information further comprising determining a net amount so that when tax is applied to the net amount, a sum of the net amount and the tax equals the gross total amount. The first request corresponds to effectuating a pre-stay relocation. The first request corresponds to effectuating an intra-stay relocation. A guest has stayed at the first unit for a first length of time as part of the time period, and wherein the intra-stay relocation comprises that the guest instead stays at the second unit for a second length of time as part of the time period. The method further comprises: crediting all receivable invoices of the booking; creating a first new receivable invoice for the booking, the first new receivable invoice associated with the stay at the first unit for the first length of time; and creating a second new receivable invoice for the booking, the second new receivable invoice being associated with the stay at the second unit for the second length of time. The first request includes a combination of primitives. The first request includes a primitive that is reused from a second request.

In a second aspect, a non-transitory computer-readable medium includes instructions that when executed cause a processor to perform operations comprising: receiving, by a revenue reconciliation service of a hospitality booking system, a first request from operational software of the hospitality booking system, the first request instructing the revenue reconciliation service to make a change regarding a booking, the change corresponding to a revenue change for the booking; providing, by the revenue reconciliation service and to the operational software in response to the first request, revenue state information for the booking, the revenue state information reflecting the change and including every active receivable invoice for the booking; receiving, by the revenue reconciliation service after providing the revenue state information, a confirmation from the operational software regarding the booking; and providing, by the revenue reconciliation service and in response to the confirmation, a sales order to an accounting system of the hospitality booking system.

In a third aspect, a hospitality booking system comprises: operational software being executed to run a booking engine; a computer-implemented accounting system; and a computer-implemented revenue reconciliation service that receives a request from the operational software about making a change regarding a booking, provides revenue state information in response to the request, receives a confirmation of the booking from the operational software, and provides a sales order regarding the booking to the computer-implemented accounting system.

### BRIEF DESCRIPTION OF DRAWINGS

FIG. 1 shows an example of a hospitality booking system.

FIG. 2 schematically shows an example of a credit and rebill pattern.

FIG. 3 shows a flowchart of an example of a process.

FIG. 4 schematically shows an example of a pre-stay relocation.

FIG. 5 schematically shows an example of an intra-stay relocation.

FIG. 6 schematically shows a booking flow where a gross total amount is maintained.

FIG. 7 illustrates an example architecture of a computing device that can be used to implement aspects of the present disclosure.

Like reference symbols in the various drawings indicate like elements.

### DETAILED DESCRIPTION

This document describes examples of systems and techniques for providing revenue reconciliation between operational software and an accounting system of a hospitality booking system. Revenue reconciliation can seek to prevent the operational software and the accounting system from falling out of synchronization with each other regarding the revenue associated with one or more bookings. In some implementations, a revenue reconciliation service implemented in the hospitality booking system can seek to ensure that the operational software and the accounting system represent the same state with regard to a given booking. The revenue reconciliation service can be a source of truth for the current revenue state within the hospitality booking system. For example, the revenue state indicates how much any given guest may owe to the hospitality provider, and for what booking(s) the amounts are owed. Such truth of the current revenue state can be established and provided at a chosen level of granularity (including, but not limited to, on a daily-rate granularity level).

Implementations can provide one or more of the following advantages. Scalability of the business model of a hospitality enterprise can be improved. A hospitality business can offer customers and/or its internal agents (e.g., sales or customer service representatives) the ability to perform actions in a self-serve procedure. A revenue reconciliation system can serve as an interface between operational software and accounting software and ensure that they both represent the same state.

Examples herein refer to a unit for which a booking can be made using a hospitality booking system. As used herein, a unit represents any physical or logical entity that can be booked. In some implementations, a unit is a dwelling that is booked for an amount of time. For example, a dwelling can include one or more of, but is not limited to, a house, an apartment, a room, an indoor space, a vehicle, a caravan, a ship, a boat, a storage, a parking spot, a bed, a seat, or an outdoor space, or combinations thereof. In some implementations, a unit includes merchandise. For example, merchandise can include, but is not limited to, food or beverage. For simplicity, the guest's use of the unit is often referred to herein as a “stay” involving the unit. However, the term stay can have a different meaning depending on the type of unit. For example, a stay involving a house or an apartment signifies that the guest temporarily resides at the unit, whereas a stay regarding another type of unit can mean that the guest temporarily uses or possesses the unit, or that the guest consumes or otherwise depletes the unit.

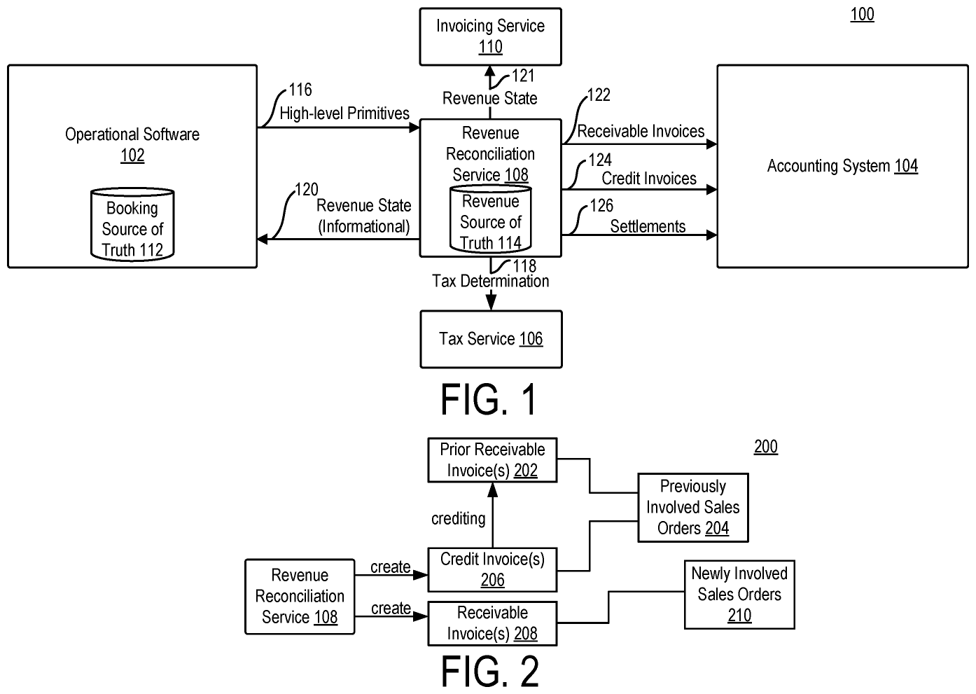

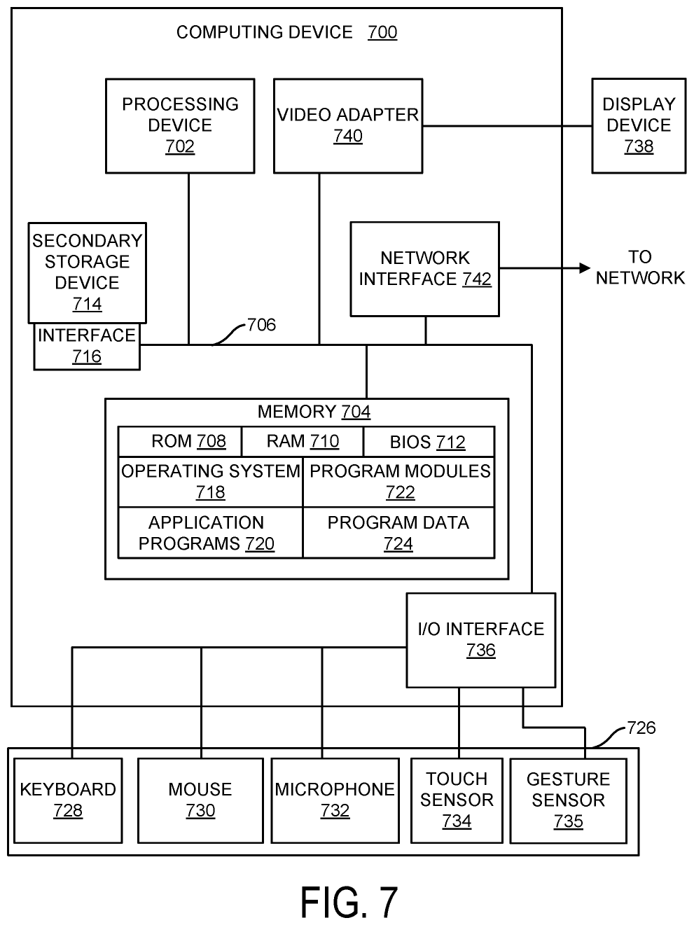

FIG. 1 shows an example of a hospitality booking system 100. The hospitality booking system 100 is schematically shown as a diagram of system components and here includes operational software 102, an accounting system 104, a tax service 106, a revenue reconciliation service 108, and an invoicing service 110. One or more of the components of the hospitality booking system 100 can be implemented in form of executable instructions stored in a non-transitory medium for execution by one or more processors, including, but not limited to, using some or all components exemplified below with reference to FIG. 7. The hospitality booking system 100 can be physically implemented using more or fewer physical components than shown in the illustration. The hospitality booking system 100 can be used with one or more other examples described elsewhere herein.

The operational software 102 can serve one or more functions for the benefit of an enterprise that provides hospitality services, including, but not limited to, managing reservations and hosting one or more customer-facing computer-based portals. The operational software 102 can serve as a central entry point for customers and/or internal user agents to check unit availability and make bookings. In some implementations, user agents of the hospitality provider can include sales representatives or customer services representatives. For example, the operational software 102 can be configured with additional complex functionality for the agents (e.g., more flexibility and more options of revenue-affecting actions) than for customers. In some implementations, the hospitality booking system 100 can be used to allow bookings regarding units to be made for customers (sometimes referred to as guests). Such bookings can be made by the guest or by an agent of the hospitality provider, to name just two examples. In some implementations, a booking engine that allows guests/agents to browse available units and make reservations can be effectuated entirely or partly by running (executing) the operational software 102. A booking engine can create booking objects or other reservation objects from user input, determine booking prices, and forward revenue information to the revenue reconciliation service 108. In some implementations, the operational software 102 can be regarded as a source of truth of bookings in the hospitality booking system 100. For example, the operational software 102 can include at least one database 112 that can be the final authority on the state of any booking.

The operational software 102 can provide one or more channels where units are marketed to guests. In some implementations, a self-service option can be provided. For example, the guest can visit an online site of the hospitality provider and choose a unit, select the amount of time, and pay for the booking (e.g., by way of a credit card transaction). As another example, the guest can interact with an application (e.g., an app) on a stationary or mobile electronic device, and such application/app functionality can be controlled or otherwise supported by the operational software 102. In some implementations, the guest can interact with a human agent of the hospitality provider in person or by phone, and the agent can create the booking for the guest using the operational software 102. Other marketing channels can be used.

The accounting system 104 is responsible for recording and reporting financial transactions performed and/or registered by the hospitality booking system 100. The accounting system 104 can provide accounting functionality including, but not limited to, some or all of: accounts payable, accounts receivable, a journal, a general ledger, stock/inventory management, purchase orders, sales orders, or bookkeeping.

The tax service 106 is responsible for calculating applicable tax on one or more items of a booking, and reporting the tax(es) to the revenue reconciliation service 108. As used herein, a tax can include any financial charge or other levy imposed by a government organization, regardless of the name used for the payment. Taxes can be defined by statutes or other regulations, and can be applicable within only a specified geographical area (a tax jurisdiction) and/or under particular circumstances.

The invoicing service 110 can be responsible for generating invoices for individual guests, a single payer in case of group sales, or their representatives. Invoices can be sent in any of multiple formats, including, but not limited to, by electronic transmission and/or in hardcopy (e.g., by mail or other delivery service). In some implementations, the invoicing service 110 can generate Portable Document Format (PDF) invoices. For example, the operational software 102 can receive a message when a PDF invoice is generated, automatically download the PDF invoice from the invoicing service 110, and send the PDF invoice to the customer by electronic communication. As another example, an internal agent of the hospitality provider can download the PDF invoice and send it to the customer through another channel, including, but not limited to, by an instant message communication.

The revenue reconciliation service 108 serves to ensure that the operational software 102 and the accounting system 104 remain synchronized with each other regarding at least the state of revenue for each guest and each booking registered by the hospitality booking system 100. The revenue reconciliation service 108 can include at least one database 114 that can serve as the source of truth for revenue state within the hospitality booking system 100. For example, a discrepancy (e.g., a contradiction) may be discovered in the respective revenue information held by two or more components of the hospitality booking system 100. Based on the revenue reconciliation service 108 being the source of truth for revenue state, such a discrepancy can be resolved by assuming that the revenue reconciliation service 108 is correct regarding the item at issue.

A guest or internal agent can use functionality of the hospitality booking system 100 to create one or more bookings. In some implementations, the guest can employ a self-service booking flow by accessing the online site of the hospitality provider or of its agent, or by using a dedicated app. Engaging with the booking flow can allow the guest to observe a limited view into the functionality of the operational software 102. The guest can then enter applicable information and make a selection from among relevant and available units. The operational software 102 can calculate or otherwise determine (e.g., using a pricing service) the price for the unit of the booking. The guest can then enter payment information and input a confirmation that the guest wishes to make the reservation (e.g., by actuating a control labeled “book now”). The operational software 102 can create a booking object that represents the guest's reservation (such booking object sometimes being referred to as an inquiry within the hospitality booking system 100) and this object can be stored by the booking engine. The operational software 102 can send a message (e.g., by wired or wireless communication, such as by using one or more networks) to the revenue reconciliation service 108 regarding the booking. The message can include a booking identifier (ID) that is unique to the created booking. The revenue reconciliation service 108, in turn, can define a sales order ID based on the booking ID. The revenue reconciliation service 108 can create a sales order for the booking based on the information from the operational software 102, and associate the sales order with the sales order ID that was defined.

A booking can be changed for any of multiple reasons. Generally, the change can be due to a circumstance involving the guest (e.g., a change in plans or preference), or a circumstance involving the hospitality provider (e.g., a change in inventory or a temporary unavailability of the booked unit). Examples of booking flows that involve changes include, but are not limited to, that the host relocates a guest to a different unit, for example such that the gross amount should be maintained the same while complying with tax rules; that the hospitality provider provides a service recovery refund to the guest, for example such that this refund is partially made against cash payments (which may reduce tax liability) and partially against hospitality-provider credits (which may not reduce tax liability); or that the length of the stay is adjusted, for example with the change crossing a monthly boundary of a fixed monthly rent agreement. By contrast, when a specific booking is initially made in the operational software 102, this is not considered a change of a booking. Rather, such booking is created (i.e., invoiced) in the revenue reconciliation service 108 after being made in the operational software 102.

In earlier systems that attempted to manage booking of hospitality reservations, the making of a change to an existing booking (e.g., any of those exemplified above) could sometimes lead to inconsistencies or errors within the system. Such situations can be difficult to resolve and often required a human with specialized engineering or accounting knowledge to intervene and manually perform data manipulation. As a result, it may be more challenging to provide a self-service option to guests or internal agents in such systems, and the systems may also be less susceptible to being scaled for handling a significantly larger number of bookings.

The hospitality booking system 100 includes the revenue reconciliation service 108 ensuring that the operational software 102 and the accounting system 104 remain synchronized with each other at least in terms of the revenue state within the hospitality booking system 100. This can be useful in a variety of situations, including, but not limited to, when booking changes are made. The revenue reconciliation service 108 ensures revenue state synchronization by being the source of truth for revenue with regard to at least the operational software 102 and the accounting system 104.

The operational software 102 can be configured to perform one or more types of booking changes in the hospitality booking system 100. The operational software 102 can send any of primitives 116 (e.g., high-level primitives) as a request to the revenue reconciliation service 108. That is, each of the primitives 116 requests the revenue reconciliation service 108 to perform a specific change. In some implementations, the primitives 116 are designed to strike a balance between ease of use and reusability. Examples of the primitives 116 include, but are not limited to:
Crediting a core stay from date X to date Y
Adding a new service charge, such as for parking, food, or beverage
Specifying each daily rate for a core stay from date A to date B
Applying a discount of $Z to the rate for a certain day of the core stay
Discounting or marking up the rate(s) for the core stay such that after all applicable taxes are applied the gross amount will be $W

In the above examples, the terms X, Y, Z, and W represent arbitrary numbers that the operational software 102 can supply depending on the situation when sending the primitive 116 to the revenue reconciliation service 108. The cost of a “core stay” can refer to a basic price before any applicable discounts or markups. For example, the core stay can be represented by a base fee line item and a cleaning fee line item, whereas ancillary revenue (e.g., food or beverage) is not included.

That is, the revenue reconciliation service 108 can receive a request from the operational software 102 to make a change regarding a booking. Such a change can correspond to a revenue change for the booking. As such, if the change is made the revenue reconciliation service 108 may need to update a revenue state to reflect a new state based on the change.

In some implementations, one or more of the primitives 116 can be reused and/or combined with at least another one of the primitives 116. This can provide advantages in terms of accomplishing booking modifications. For example, this can eliminate or reduce the need to create new request types for every type of modification (e.g., pre-stay relocation, stay length adjustment, refunds, etc.). Examples of reusing and/or combining the primitives 116 can include, but are not limited to, the following.

A pre-stay relocation can be accomplished using:
A first primitive to credit out the core stay from day X to day Y on a first sales order;
A second primitive to invoice a new core stay from day X to day Y on a second sales order; and
A third primitive to specify that any resulting refunds should be made by way of the original payment method.

An intra-stay relocation on the nth day of a stay can be accomplished using:
A first primitive to credit out the core stay from day X+n to day Y on a first sales order;
A second primitive to invoice a new core stay from day X+n to day Y on a second sales order; and
A fourth primitive to adjust the invoice generated by the second primitive to match the gross total of the corresponding days of the first primitive, while considering tax, to avoid settlements (e.g., charges or refunds). For example, the fourth primitive can be optional and be used if the hospitality provider plans to not hold the guest liable for increased costs of the intra-stay relocation.

A specific refund can be accomplished using:
A fifth primitive to add a reduction line item (e.g., a service recovery) to an existing line item;
A sixth primitive to distribute the entered total amount proportionally to the (base fee) daily amounts of the line item it reduces; and
A seventh primitive to refund to credits redeemable by the hospitality provider instead of a credit card.

That is, the operational software 102 can generate a request that includes a combination of primitives. As another example, the operational software 102 can generate a request including a primitive that is reused from another request.

The revenue reconciliation service 108 can determine a revenue state in response to receiving the primitive 116 or a combination of two or more of the primitives 116. In some implementations, the revenue reconciliation service 108 makes such a determination using a credit and rebill pattern. For example, the revenue reconciliation service 108 can credit all receivable invoices of the booking being changed that are rendered obsolete by the modification, and also optionally create at least one new receivable invoice for the booking (or create no new receivable invoice as in the situation of some cancellations), wherein the new receivable invoice reflects the change that was requested by the operational software 102.

The revenue reconciliation service 108 can take tax liability into account in creating the new receivable invoice. In some implementations, the revenue reconciliation service 108 sends a request 118 to the tax service 106 for a new tax determination. The request 118 can include information about the change and other aspects of the booking. For example, as a result of the change the stay may instead occur in a different jurisdiction than when the booking was originally created, or the duration of the stay may be different. The tax service 106 performs a tax determination based on the information applicable to the booking as changed, and provides a response to the revenue reconciliation service 108.

The revenue reconciliation service 108 sends revenue state information 120 to the operational software 102 in response to the request. The revenue state information 120 reflects the change that the operational software 102 requested by way of the primitive 116. For example, the revenue state information 120 includes every active (i.e., not credited) receivable invoice for the booking. As mentioned in an example above, the revenue reconciliation service 108 may create the new receivable invoice(s) for the booking as part of determining the revenue state. Accordingly, the revenue state information 120 can reflect the receivable invoice(s) that the booking now encompasses. In some implementations, the revenue reconciliation service 108 can provide the revenue state information 120 to the operational software 102 not as part of actually invoicing the guest for the booking, but only to communicate what the revenue state is (or might be). For example, the revenue state information 120 can be informational.

The revenue reconciliation service 108 can provide the revenue state information 120 to the operational software 102 in a preview mode. This can allow the operational software 102 to present the changed revenue state information of the booking to the guest or internal agent, and the guest/agent can decide whether to go through with making the change to the booking. In some implementations, the database 114 can be designed to have a confirmation flag that can be applied to one or more items of information stored therein. For example, the confirmation flag can include a field that stores a confirmation date, with an absence of a date in that field signifying that the transaction is not confirmed. Every modification can start off in a preview mode (e.g., as described elsewhere herein); only if the operational software 102 explicitly confirms the transaction with an additional message is the date set and the modification then becomes effective. The revenue reconciliation service 108 can control this confirmation flag to reflect whether the change requested by the operational software 102 has actually been made, or whether the revenue state information 120 is provided in a preview mode. That is, when the revenue reconciliation service 108 provides the revenue state information 120 to the operational software 102 in the preview mode, the confirmation flag may not be set on the revenue state information 120 in the database 114. If the revenue reconciliation service 108 later receives a confirmation of the change in the booking from the operational software 102, the revenue reconciliation service 108 can set the confirmation flag on the revenue state information 120 in the database 114 in response to such confirmation.

The operational software 102 can send a message to the revenue reconciliation service 108 to indicate a settlement regarding the booking. A settlement can include a payment or a refund. For example, if the guest makes a payment for the booking, or the hospitality provider provides a refund to the guest, the operational software 102 registers this as a settlement for the booking. Accordingly, the revenue reconciliation service 108 can receive settlement information from the operational software 102 regarding the booking, and can associate the settlement with the sales order that represents the booking.

In some implementations, such a refund can be effectuated as follows. A hospitality agent can request the refund using the operational software 102. The operational software 102 can send a message to the revenue reconciliation service 108 requesting to add a reduction of $x. The revenue reconciliation service 108 can create a credit invoice that credits out the receivable invoice containing the to-be-reduced line item and create a new receivable invoice reflecting the reduced amount. The revenue reconciliation service 108 can determine that there is now an overpayment, because what had been paid is now more than the new total amount. The revenue reconciliation service 108 can instruct the operational software 102 in the revenue state response to refund. The operational software 102 can refund the money using a payment processor and then send a settlement message containing the processed refund to the revenue reconciliation service 108, which can record the processed refund.

The revenue reconciliation service 108 can provide one or more types of information to another component of the hospitality booking system 100. The revenue reconciliation service 108 can provide a revenue state 121 to the invoicing service 110. The revenue state 121 can include essentially the same contents as the revenue state information 120 provided to the operational software 102. For example, the revenue state 121 can be provided for the purpose of having the invoicing service 110 issue one or more invoice documents regarding the booking.

The revenue reconciliation service 108 can provide the sales order associated with the booking (e.g., where the sales order ID corresponds to the booking ID) to the accounting system 104. For example, the revenue reconciliation service 108 may not release information to the accounting system 104 about the booking until the guest has paid at least the first settlement for the stay. At that time, the sales order and related information can be released to the accounting system 104. In some implementations, receivable invoices 122 can be provided. For example, the revenue reconciliation service 108 may have created the receivable invoices 122 when the sales order for the booking was originally generated, or the revenue reconciliation service 108 may have created the receivable invoices 122 as part of executing a credit and rebill pattern. In some implementations, credit invoices 124 can be provided. For example, the revenue reconciliation service 108 may have created the credit invoices 124 as part of executing a credit and rebill pattern. In some implementations, settlements 126 can be provided. For example, the revenue reconciliation service 108 may have created the settlements 126 upon being notified by the operational software 102 about a payment or refund.

Operation of the hospitality booking system 100 illustrates an example of performing a method that includes receiving, by a revenue reconciliation service (e.g., the revenue reconciliation service 108) of a hospitality booking system (e.g., the hospitality booking system 100), a first request (e.g., the primitive 116) from operational software (e.g., the operational software 102) of the hospitality booking system, the first request instructing the revenue reconciliation service to make a change regarding a booking, the change corresponding to a revenue change for the booking. The method includes providing, by the revenue reconciliation service and to the operational software in response to the first request, revenue state information (e.g., the revenue state information 120) for the booking, the revenue state information reflecting the change and including every active receivable invoice for the booking. The method includes receiving, by the revenue reconciliation service after providing the revenue state information, a confirmation from the operational software regarding the booking. For example, the revenue state information may have been provided in a preview state to be finalized in response to a possible confirmation from the guest or internal agent. The method includes providing, by the revenue reconciliation service and in response to the confirmation, a sales order (e.g., the receivable invoices 122, credit invoices 124, and/or settlements 126) to an accounting system (e.g., the accounting system 104) of the hospitality booking system.

FIG. 2 schematically shows an example of a credit and rebill pattern 200. The credit and rebill pattern 200 can be used with one or more other examples described elsewhere herein. The credit and rebill pattern 200 relates to situations when changes are made to an existing booking, and how this affects revenue state. In prior approaches to hospitality booking, receivable invoices may have been partially credited upon a change occurring, and the revenue of the updated stay details may have been incrementally updated. However, such efforts can quickly lead to confusing or contradictory results. For example, the revenue can inadvertently be put into a state that application logic (e.g., the operational software 102 in FIG. 1) can make only few if any assumptions about. As such, such modifications of bookings have often been error prone. With the revenue reconciliation service 108 in FIG. 1 each action in the hospitality booking system 100 that causes a change in revenue (or that would cause a revenue change if made) can also credit all affected receivable invoices by generating credit invoices in the same amounts (if applicable) and re-invoice (e.g., rebill) the updated state as a set of new receivable invoices. In some implementations, the currently active set of invoices thus created can effectively be a pristine booking that computer code can validly make assumptions about. For example, this can significantly decrease the number of errors and can enable revenue reconciliation for many use cases that may have been problematic in prior systems.

Here, the revenue reconciliation service 108 has created one or more prior receivable invoices 202 for a booking. The prior receivable invoices 202 can be associated with one or more previously involved sales orders 204. Upon a change to the booking being received, the prior receivable invoice(s) 202 can be credited by a crediting action. For example, the revenue reconciliation service 108 can create one or more credit invoices 206 that has the negated amount of the prior receivable invoice(s) 202 to be credited. That is, the credit invoice(s) 206 can also be associated with the previously involved sales order(s) 204. The revenue reconciliation service 108 can create one or more receivable invoices 208 for the booking. The receivable invoice(s) 208 can be associated with one or more newly involved sales orders 210.

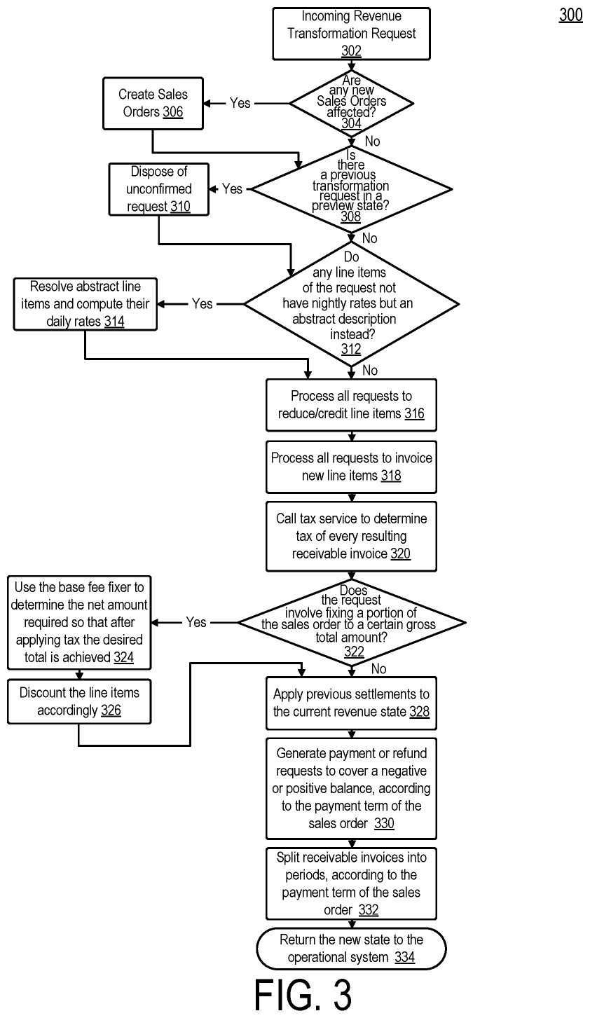

FIG. 3 shows a flowchart of an example of a process 300. More or fewer operations than shown can be performed. Two or more operations can be performed in a different order unless otherwise indicated. The process 300 can be used with one or more other examples described elsewhere herein. For example, the process 300 can be performed by the revenue reconciliation service 108 in FIG. 1.

In operation 302, an incoming revenue transformation request can be received. For example, a sales order may previously have been created for a booking, and the request that is here received can call for a transformation of some aspect of the booking. In some implementations, the revenue reconciliation service 108 in FIG. 1 can perform an upfront validation in response to receiving a request. If the validation reveals a problem, a validation error can be raised in the system, and/or the state can be rolled back to the previous situation and a reporting can be made to the originator of the request. For example, if the requested transformation is for a $200 discount of a line item that is only $150, then the transformation may not pass the upfront validation.

In operation 304, it can be determined whether the request involves a transformation that implicates any “new sales order”—e.g., a sales order that is presently unknown to the revenue reconciliation service 108. That is, the revenue reconciliation service 108 can consider, for any creation of a new stay, whether previous information exists about the sales order or whether the sales order is a new one. In some implementations, every request can potentially involve or affect multiple sales orders. For example, if a relocation of a booking is to be performed, the request may include information on two sales orders: a source sales order and a target sales order, or even multiple target sales orders in case of a split relocation (e.g., where no unit is available for the entire duration but a combination of multiple units may cover the stay). That is, in a relocation the source sales order had already been created and the target sales order can be created for purposes of effectuating the requested transaction. The new sales order(s) can be created at operation 306.

If the answer is no to the determination in operation 304, or after performing the operation 306, the process 300 can perform operation 308, in which can be determined whether there exists a previous transformation request for this sales order that is in a preview state. In some implementations, the revenue reconciliation service 108 may have previously received a request to which it responded by providing revenue state information in a preview state. For example, a hospitality agent may enter into the system a proposed refund of $50 before tax. Upon receiving the request for such a transformation, the revenue reconciliation service 108 can determine that this corresponds to a refund of $66 after tax, and a preview of the revenue state information can then be generated. That revenue state information can be stored in the system in a preview mode. If the agent that received the revenue state information did not go through with the change, then the request can remain in the system as an unconfirmed transaction. If the guest is later to be relocated, say, the preview of the refund can still show up for the applicable sales order. The process 300 can dispose of the unconfirmed request(s) in an operation 310. For example, if there are multiple sales involved in the request, this is done for all of the sales orders.

If the answer is no to the determination in operation 308, or after performing the operation 310, the process 300 can perform operation 312, in which it can be determined whether the request is expressed using a preferred metric. In some implementations, the operation 312 can determine whether the request is formulated in terms of a daily rate (sometimes instead referred to as a nightly rate) for a stay, which may be a preference in the hospitality booking system. For example, when the transformation request involves adding a new line item to a sales order or a receivable invoice, the operational software 102 in FIG. 1 can send explicit daily rates with the request to provide defined dollar amounts per day. As another example, if the request adds a discount to a line item, the request can merely specify the total amount rather than give a daily rate, and a flag can then be set to distribute the discount based on the parent line-item daily amounts. That is, if the base fees for three days are $100, $100, and $200, respectively, and the total discount is $200, the amounts of the discount applied to the first two days would each be less than the amount for the third day. Such calculations can be performed at operation 314, for example by the revenue reconciliation service 108 in FIG. 1. The outcome of the operation 314 can be that the request has daily rates for every line item.

If the answer is no to the determination in operation 312, or after performing the operation 314, the process 300 can perform operation 316, in which all requests that are explicitly to reduce line items or credit line items are processed. For example, the operation 316 involves processing those requests where a discount is to be added to an existing line item. As another example, if a guest cancels a booking at least a certain time before the stay, a policy may apply that the guest receives a certain percentage of the cost as a refund. As another example, if a line item is to be credited, a crediting action can be performed and the system then registers that it has performed a crediting action for that line item-invoice combination.

In operation 318, all requests to invoice new line items are processed. In some implementations, discounts can be applied to more than one line item of an invoice. The process 300 may already have credited an invoice as part of a credit and rebill pattern, and stored information that this was done. A second one of the primitives 116 (FIG. 1) may also be received within the same request and involve adding discounts to two line items of the same invoice. When processing the discounts, the process would not attempt to credit the invoice (because it had already been done). Rather, the process now has two new line items to add according to the presently processed request. The process 300 would then store information about all line items that were on the invoice, the applied modification (e.g., the new reduction), all child line items, et cetera. Later, the process 300 would take all line items that it stored in processing the requests and create a new set of invoices.

In operation 320, the process 300 can call a tax service. In some implementations, the applicable tax can be determined by the tax service 106 in FIG. 1 for every resulting receivable invoice. For example, with every line item for which an amount of tax is applicable, a tax line item can be generated.

In operation 322, it can be determined whether the request involves maintaining a particular gross total amount. In some implementations, a guest may be relocated from one unit to another. Before making the booking the guest may have received a quote of $800 including tax. The other unit may be in a different tax jurisdiction (or may otherwise have a different applicable tax). The request can instruct the process 300 to adjust one or more line items so that after the newly applicable tax is applied, the gross total amount for the guest remains the same as before. The determination of the required new amount can be performed in operation 324. In operation, one or more line items can be discounted based on the gross total amount and the required new amount. The revenue reconciliation service 108 can map this to the rest of the receivable invoice. In some implementations, the line item can have discounts applied, so that the base fee may be $100, a first discount is $20, and a second discount is $10. Accordingly, the remaining revenue of the base fee may be $70. The revenue reconciliation service can then invoke the tax service regarding the $70, which can determine that the particular line item then needs to be $52. The revenue reconciliation service can map that figure back to the discount items so that it adds up to $52. That is, when the booking is associated with a gross total amount for the stay, a net amount can be determined so that when tax is applied to the net amount, a sum of the net amount and the tax equals the gross total amount.

If the answer is no to the determination in operation 322, or after performing the operation 326, the process 300 can perform operation 328, in which one or more previous settlements can be applied to the current revenue state. In a hospitality booking system, each settlement—which may be a payment or a refund—is initially associated with a receivable invoice. When a receivable invoice is credited (e.g., as part of a credit and rebill pattern), the settlement can be said to be “freed up” in the system, in the sense that the receivable invoice to which the settlement had been applied has now been credited out. The system therefore stores information about the settlements for applying them to a new receivable invoice. When the settlement is instead associated with the new receivable invoice, any of three situations can occur in operation 330: the old and new invoice amounts are the same, in which case no action may be taken; or a negative balance exists and a refund object can be created; or a positive balance exists and that open balance can be reported.

In operation 332, one or more receivable invoices can be split. In some implementations, partial installment payments can be offered for a booking. For example, monthly installments can be used for long term stays (LTS). The details of such splitting of receivable invoices may not be handled by the booking engine, in the interest of maintaining a common source of truth in the hospitality booking system. Rather, a revenue reconciliation service can handle such installment payments. That is, the booking engine can send to the revenue reconciliation service the daily rates for the entire stay (e.g., a time period of several months or years) and set a flag—e.g., for a payment term—that LTS terms are applicable to the payment. The revenue reconciliation service can then split the term of the invoice into the applicable invoicing periods, and use those invoicing periods as the basis for sending receivable invoices to the accounting system at the applicable intervals.

At operation 334, the process 300 can return the new revenue state information to the booking engine (e.g., the operational software 102 in FIG. 1). If the revenue reconciliation service is operating in preview mode, the transaction may yet be unconfirmed at this point.

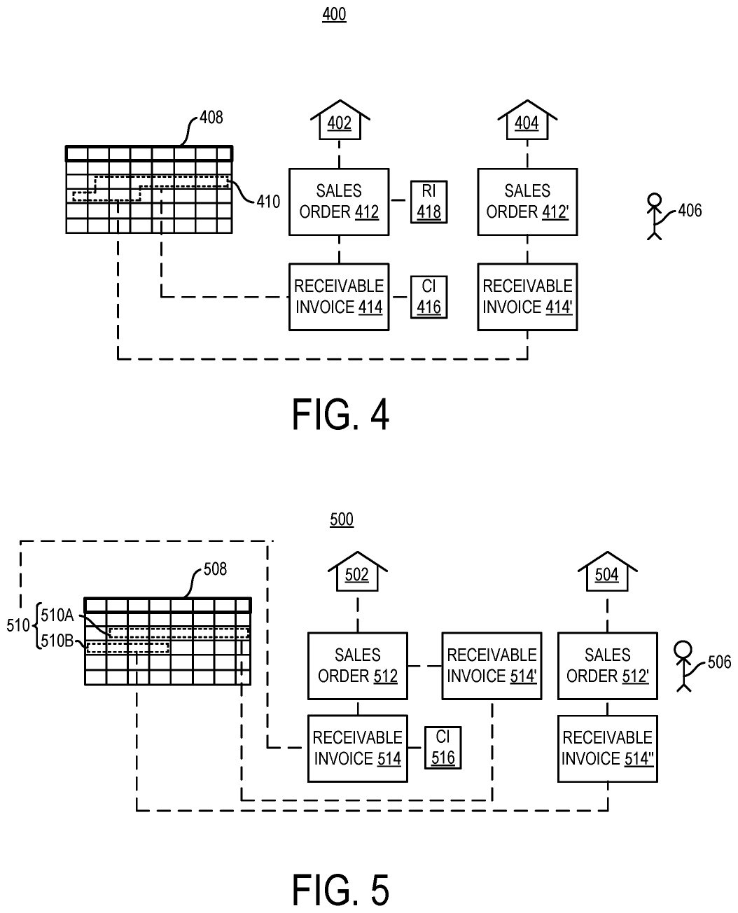

FIG. 4 schematically shows an example of a pre-stay relocation 400. The pre-stay relocation 400 can be used with one or more other examples described elsewhere herein. In short, the pre-stay relocation 400 describes a situation where a guest is relocated before the stay has begun, and the way that a system can handle the new revenue state.

The pre-stay relocation 400 involves at least a unit 402 and a unit 404. Initially, a guest 406 is booked for a stay involving the unit 402. A calendar 408 here schematically illustrates that the booking covers a time period 410. For example, the time period 410 can extend over multiple days. A sales order 412 has been created for the booking, and a receivable invoice 414 indicates the amount of payment due by the guest. The sales order 412 and the receivable invoice 414 are associated with each other, and with the unit 402 and the time period 410, as schematically illustrated by dashed lines.

Before the time period 410, the pre-stay relocation 400 to the unit 404 occurs by way of sending a request to a revenue reconciliation service. This can be done because the guest 406 wishes to switch units, or because the hospitality provider must instead offer a different unit for the booking, to name just two examples. As such, the booking can initially comprise a stay at the unit 402 for the time period 410, and the change specified by the request comprises a relocation of the stay from the unit 402 to the unit 404 for at least part of the time period 410 (e.g., the entire time period 410).

The revenue reconciliation service can create a sales order 412′ for the pre-stay relocation 400. The sales order 412′ can correspond to and replace the sales order 412 in the hospitality booking system. The revenue reconciliation service can create a receivable invoice 414′. The receivable invoice 414′ can correspond to and replace the receivable invoice 414 in the hospitality booking system. The sales order 412′ and the receivable invoice 414′ are associated with each other, and with the unit 404 and the time period 410, as schematically illustrated by dashed lines.

During the relocation process, the revenue reconciliation service can also create a credit invoice (CI) 416 that credits out the receivable invoice 414 before the receivable invoice 414′ is invoiced. Any ancillary revenue that may have already existed on the sales order 412 can be covered by the credit invoice 416 but can then be re-invoiced on a receivable invoice (RI) 418 that will continue to be associated with the sales order 412 (e.g., the receivable invoice 418 is not moved to the sales order 412′).

FIG. 5 schematically shows an example of an intra-stay relocation 500. The intra-stay relocation 500 can be used with one or more other examples described elsewhere herein. In short, the intra-stay relocation 500 describes a situation where a guest is relocated during the stay, and the way that a system can handle the new revenue state.

The intra-stay relocation 500 involves at least a unit 502 and a unit 504. Initially, a guest 506 is booked for a stay involving the unit 502, and begins the stay at the unit 502. A calendar 508 here schematically illustrates that the booking covers a time period 510 that includes a length of time 510A and a length of time 510B. A sales order 512 has been created for the booking, and a receivable invoice 514 indicates the amount of payment due by the guest. The sales order 512 and the receivable invoice 514 are associated with each other, and with the unit 502 and the time period 510, as schematically illustrated by dashed lines.

During the length of time 510A when the guest 506 stays at the unit 502, the intra-stay relocation 500 to the unit 504 occurs by way of sending a request to a revenue reconciliation service. This can be done because the guest 506 wishes to switch units, or because the hospitality provider must instead offer a different unit for the booking, to name just two examples. As such, the guest 506 has stayed at the unit 502 for the length of time 510A as part of the time period 510, and the intra-stay relocation 500 comprises that the guest 506 instead stays at the unit 504 for the length of time 510B as part of the time period 510.

The revenue reconciliation service can create a sales order 512′ for the intra-stay relocation 500. The sales order 512′ can correspond to the stay at the unit 504 for the length of time 510B. The revenue reconciliation service can create receivable invoices 514′ and 514″ for the intra-stay relocation 500. The sales order 512 and the receivable invoice 514′ are associated with each other, and with the unit 502 and the length of time 510A, as schematically illustrated by dashed lines. The sales order 512′ and the receivable invoice 514″ are associated with each other, and with the unit 504 and the length of time 510B, as schematically illustrated by dashed lines.

During the relocation process, the revenue reconciliation service can also create a credit invoice 516 that credits out the receivable invoice 514 before the receivable invoice 514′ is invoiced. Any ancillary revenue that may have already existed on the sales order 512 can be covered by the credit invoice 516 but can then be re-invoiced on the receivable invoice 514′ that will continue to be associated with the sales order 512 (e.g., the receivable invoice 514′ is not moved to the sales order 512′).

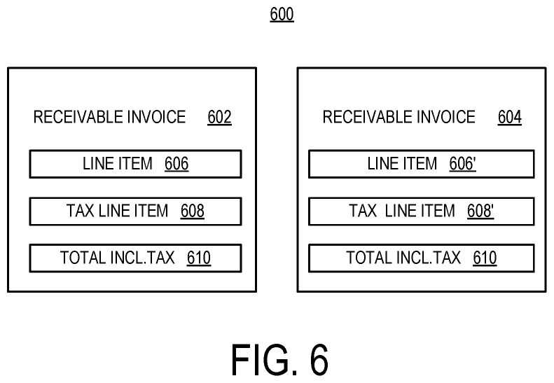

FIG. 6 schematically shows a booking flow 600 where a gross total amount is maintained. The booking flow 600 is an example of one of the primitives 116 in FIG. 1. The booking flow 600 can be used with one or more other examples described elsewhere herein.

A hospitality booking system has created receivable invoices 602 and 604. The receivable invoice 602 can be referred to as a previous receivable invoice because it may have been created when a booking was initially made. The receivable invoice 604, by contrast, can be created as a result of making a change in the booking, and the present example illustrates how revenue state information can be handled by the hospitality booking system.

The receivable invoice 602 includes a line item 606 that represent an aspect of the booking. For example, the line item 606 can represent a base fee for a stay involving a particular unit. The line item 606 is associated with a tax line item 608. For example, the tax line item 608 was calculated for the line item 606 by the tax service 106 in FIG. 1 so that the revenue reconciliation service 108 could initially provide the revenue state information 120 regarding the booking to the operational software 102. The receivable invoice 602 includes a total amount 610. For example, the total amount 610 can be specified as including tax.

Due to a request for a change in the booking that may implicate a different tax liability, the receivable invoice 602 can be credited in the hospitality booking system. Instead, the receivable invoice 604 should include revenue information that is now applicable to this stay for the guest. Assume, moreover, that the total amount 610 should remain the same for the receivable invoice 604 as it was for the receivable invoice 602 (for example, the hospitality provider may wish to provide the guest the same cost for the stay despite the change in the booking). A tax service can determine a tax line item 608′ that is applicable to the change in the booking according to the receivable invoice 604. The tax line item 608′ may be different from the tax line item 608. Moreover, the revenue reconciliation service can determine a line item 606′ based on the total amount 610. The functionality can be designed to determine the net price at which the hospitality provider needs to sell so that after all applicable tax (which is unknown to the operational software) is applied, the gross total will be a specific amount. The revenue reconciliation service then only needs the details of the line item 606′ except for the amount, and the revenue reconciliation service needs the desired gross total to determine what the amount of the line item 606′ and the tax line item 608′ must be. The line item 606′ may be different from the line item 606. Accordingly, the receivable invoice 604 can include the line item 606′, the tax line item 608′, and the total amount 610, wherein the line item 606′ and the tax line item 608′ reflect the change that was made in the booking, and wherein the total amount 610 here remains the same as before the change was made.

FIG. 7 illustrates an example architecture of a computing device 700 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 7 can be used to execute the operating system, application programs, and/or software modules (including the software engines) described herein.

The computing device 700 includes, in some embodiments, at least one processing device 702 (e.g., a processor), such as a central processing unit (CPU). A variety of processing devices are available from a variety of manufacturers, for example, Intel or Advanced Micro Devices. In this example, the computing device 700 also includes a system memory 704, and a system bus 706 that couples various system components including the system memory 704 to the processing device 702. The system bus 706 is one of any number of types of bus structures that can be used, including, but not limited to, a memory bus, or memory controller; a peripheral bus; and a local bus using any of a variety of bus architectures.

Examples of computing devices that can be implemented using the computing device 700 include a desktop computer, a laptop computer, a tablet computer, a mobile computing device (such as a smart phone, a touchpad mobile digital device, or other mobile devices), or other devices configured to process digital instructions.

The system memory 704 includes read only memory 708 and random access memory 710. A basic input/output system 712 containing the basic routines that act to transfer information within computing device 700, such as during start up, can be stored in the read only memory 708. In some implementations, the basic input/output system 712 can be replaced by a software interface between an operating system and platform firmware, such as a unified extensible firmware interface (UEFI).

The computing device 700 also includes a secondary storage device 714 in some embodiments, such as a hard disk drive, for storing digital data. The secondary storage device 714 is connected to the system bus 706 by a secondary storage interface 716. The secondary storage device 714 and its associated computer readable media provide nonvolatile and non-transitory storage of computer readable instructions (including application programs and program modules), data structures, and other data for the computing device 700.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or storage media accessed via a network, including, but not limited to, a cloud-based storage.

A number of program modules can be stored in secondary storage device 714 and/or system memory 704, including an operating system 718, one or more application programs 720, other program modules 722 (such as the software engines described herein), and program data 724. The computing device 700 can utilize any suitable operating system.

In some embodiments, a user provides inputs to the computing device 700 through one or more input devices 726. Examples of input devices 726 include a keyboard 728, mouse 730, microphone 732 (e.g., for voice and/or other audio input), touch sensor 734 (such as a touchpad or touch sensitive display), and gesture sensor 735 (e.g., for gestural input). In some implementations, the input device(s) 726 provide detection based on presence, proximity, and/or motion. Other embodiments include other input devices 726. The input devices can be connected to the processing device 702 through an input/output interface 736 that is coupled to the system bus 706. These input devices 726 can be connected by any number of input/output interfaces, such as a parallel port, serial port, game port, or a universal serial bus. Wireless communication between input devices 726 and the input/output interface 736 is possible as well, and includes infrared, BLUETOOTH® wireless technology, 802.11a/b/g/n/ac/ad/af/2016/ah/ai/aj/aq/2020/ax/ay/ba/be, cellular, ultra-wideband (UWB), ZigBee, or other radio frequency communication systems in some possible embodiments, to name just a few examples.

In this example embodiment, a display device 738, such as a monitor, liquid crystal display device, light-emitting diode display device, projector, e-Ink display, or touch sensitive display device, is also connected to the system bus 706 via an interface, such as a video adapter 740. In addition to the display device 738, the computing device 700 can include various other peripheral devices (not shown), such as speakers or a printer.

The computing device 700 can be connected to one or more networks through a network interface 742. The network interface 742 can provide for wired and/or wireless communication. In some implementations, the network interface 742 can include one or more antennas for transmitting and/or receiving wireless signals. When used in a local area networking environment or a wide area networking environment (such as the Internet), the network interface 742 can include an Ethernet or fiber optic interface. Other possible embodiments use other communication devices. For example, some embodiments of the computing device 700 include a modem for communicating across the network.

The computing device 700 can include at least some form of computer readable media. Computer readable media includes any available media that can be accessed by the computing device 700. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 700.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 7 is also an example of programmable electronics, which may include one or more such computing devices, and when multiple computing devices are included, such computing devices can be coupled together with a suitable data communication network so as to collectively perform the various functions, methods, or operations disclosed herein.

The terms “substantially” and “about” used throughout this Specification are used to describe and account for small fluctuations, such as due to variations in processing. For example, they can refer to less than or equal to +5%, such as less than or equal to ±2%, such as less than or equal to +1%, such as less than or equal to ±0.5%, such as less than or equal to +0.2%, such as less than or equal to +0.1%, such as less than or equal to +0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method comprising:
receiving, by a revenue reconciliation service of a hospitality booking system, a first request from operational software of the hospitality booking system, the first request instructing the revenue reconciliation service to make a change regarding a booking, the change corresponding to a revenue change for the booking;
providing, by the revenue reconciliation service and to the operational software in response to the first request, revenue state information for the booking, the revenue state information reflecting the change and including every active receivable invoice for the booking;
receiving, by the revenue reconciliation service after providing the revenue state information, a confirmation from the operational software regarding the booking; and
providing, by the revenue reconciliation service and in response to the confirmation, a sales order to an accounting system of the hospitality booking system.

2. The method of claim 1, wherein the revenue reconciliation service provides the revenue state information in a preview mode.

3. The method of claim 2, wherein providing the revenue state information in the preview mode involves a confirmation flag not being set on the revenue state information in a database of the revenue reconciliation service when the revenue state information is provided, the method further comprising setting, by the revenue reconciliation service and in response to the confirmation, the confirmation flag on the revenue state information in the database.

4. The method of claim 3, further comprising checking, by the revenue reconciliation service and in response to the first request, whether the database includes an unconfirmed previous request regarding the booking.

5. The method of claim 4, wherein the database does include the unconfirmed previous request regarding the booking, the method further comprising disposing of the unconfirmed previous request before providing the revenue state information.

6. The method of claim 1, further comprising determining the revenue state information by the revenue reconciliation service and in response to the first request.

7. The method of claim 6, wherein determining the revenue state information comprises:
crediting all receivable invoices of the booking; and
creating a new receivable invoice for the booking, the new receivable invoice reflecting the change according to the first request.

8. The method of claim 7, wherein creating the new receivable invoice comprises performing a new tax determination for the booking regarding the change.

9. The method of claim 8, wherein a previous receivable invoice of the booking included a first line item associated with a first tax line item, wherein creating the new receivable invoice comprises including a second line item associated with a second tax line item, and wherein the second line item and the second tax line item reflect the change.

10. The method of claim 7, wherein the operational software had notified the revenue reconciliation service, before the revenue reconciliation service provided the revenue state information, about a settlement that had been received regarding the booking, the method further comprising applying the settlement to the new receivable invoice for the booking.

11. The method of claim 1, wherein the change is at least partially specified by a line item included in the first request, the method further comprising determining, by the revenue reconciliation service, whether a daily rate is specified for the line item.

12. The method of claim 11, whether in response to a determination that no daily rate is specified for the line item, the method further comprises computing the daily rate for the line item and including the daily rate in the revenue state information.

13. The method of claim 1, wherein the booking initially comprised a stay at a first unit for a time period, and wherein the change specified by the first request comprises a relocation of the stay from the first unit to a second unit for at least part of the time period.

14. The method of claim 13, wherein the booking is associated with a gross total amount for the stay at the first unit for the time period, wherein providing the revenue state information further comprising determining a net amount so that when tax is applied to the net amount, a sum of the net amount and the tax equals the gross total amount.

15. The method of claim 13, wherein the first request corresponds to effectuating a pre-stay relocation.

16. The method of claim 13, wherein the first request corresponds to effectuating an intra-stay relocation.

17. The method of claim 16, wherein a guest has stayed at the first unit for a first length of time as part of the time period, and wherein the intra-stay relocation comprises that the guest instead stays at the second unit for a second length of time as part of the time period.

18. The method of claim 17, the method further comprising:
crediting all receivable invoices of the booking;
creating a first new receivable invoice for the booking, the first new receivable invoice associated with the stay at the first unit for the first length of time; and
creating a second new receivable invoice for the booking, the second new receivable invoice being associated with the stay at the second unit for the second length of time.

19. The method of claim 1, wherein the first request includes a combination of primitives.

20. The method of claim 1, wherein the first request includes a primitive that is reused from a second request.

21. A non-transitory computer-readable medium including instructions that when executed cause a processor to perform operations comprising:
receiving, by a revenue reconciliation service of a hospitality booking system, a first request from operational software of the hospitality booking system, the first request instructing the revenue reconciliation service to make a change regarding a booking, the change corresponding to a revenue change for the booking;
providing, by the revenue reconciliation service and to the operational software in response to the first request, revenue state information for the booking, the revenue state information reflecting the change and including every active receivable invoice for the booking;
receiving, by the revenue reconciliation service after providing the revenue state information, a confirmation from the operational software regarding the booking; and
providing, by the revenue reconciliation service and in response to the confirmation, a sales order to an accounting system of the hospitality booking system.

22. A hospitality booking system comprising:
operational software being executed to run a booking engine;
a computer-implemented accounting system; and
a computer-implemented revenue reconciliation service that receives a request from the operational software about making a change regarding a booking, provides revenue state information in response to the request, receives a confirmation of the booking from the operational software, and provides a sales order regarding the booking to the computer-implemented accounting system.
